(19) United States
(12) Patent Application Publication
(10) Pub. No.: US 2008/0137795 A1
(43) Pub. Date: Jun. 12, 2008

(54) METHOD AND APPARATUS FOR REMOVING CORROSION PRODUCTS FROM A NUCLEAR REACTOR

(75) Inventor: Dennis Frank Hussey, Mountain View, CA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Charlotte, NC (US)

(21) Appl. No.: 11/551,325

(22) Filed: Oct. 20, 2006

(51) Int. Cl. G21C 9/00

(52) U.S. Cl. 376/283

(57) ABSTRACT

A vacuum assembly for cleaning foreign matter from a nuclear reactor vessel, vessel components, and reactor coolant during reactor outage. The assembly includes a vacuum head for being inserted into the vessel and a first pump fluidly communicating with the vacuum head for directing water under pressure in the area of the vacuum head onto component surfaces within the vessel to be cleaned and thereby dislodging foreign matter from the surfaces into suspension in the reactor coolant. A filter removes foreign matter suspended in the reactor coolant from the reactor coolant. A second pump communicates with the vacuum head for pumping reactor coolant through the filter from an upstream side to a downstream side for accumulating foreign matter on an upstream side of the filter while passing filtered coolant therethrough.

### TECHNICAL FIELD AND BACKGROUND OF THE INVENTION

This invention relates to a method and apparatus for removing corrosion products from a nuclear reactor. Reactor coolant cleanup is normally accomplished during shutdown using ion exchange and filtration, and the EPRI Ultrasonic Fuel Cleaning method is applied by several utilities. However, some of the activated corrosion products may release from the fuel after coolant cleanup during refueling and settle to the bottom of the core. Redistribution of these corrosion products, colloquially referred to as “crud” or “reload crud”, as opposed to the gradual accumulation of corrosion products released from the steam generators, is suspected to occur. PWR Axial Offset Anomaly Guidelines, Revision 1.

Axial Offset Anomaly (AOA) is a phenomenon which causes anomalous neutron flux behavior at plants operating with high-energy cores. Activity and foreign material removal is the central focus of this application. Plants that experience AOA may have more crud than is typical.

In most AOA cases, flux depressions have been measured on high-powered feed assemblies. Crud deposition and AOA are functions of subnucleate boiling (“SNB”), which is typically highest in the feed assemblies. This crud can become activated to radioactive contaminants such as cobalt-58 and cobalt-60. When these activation products distribute through the system, they may deposit on the ex-core surfaces and increase the radiation fields of the plant. Crud carryover from once and twice burned re-insert fuel is not a new concept, but has been evaluated more thoroughly over the past several years as a contributing source of crud for AOA affected feed assemblies.

The location and transport mechanism of the crud-carryover continue to be studied. Essentially, there are two possible mechanisms. First, the crud may be released from the reload assembly during operations or shutdown and be redeposited on the fuel or filtered; or second, it may be released from the fuel during reload operations and eventually settle to the bottom of the core. Additionally, small foreign material inside the reactor, such as wire brush bristles, has become a significant challenge in the nuclear industry because this material cannot be trapped by the fuel assembly debris filters and may potentially damage the fuel clad. As is shown in FIG. 1, the core plate is located beneath the fuel assemblies and above the flow mixer plate and bottom support forging. Removal of the core plate is typically not possible during standard refueling outages, and this prevents debris removal from under the core plate using typical techniques.

### SUMMARY OF THE INVENTION

Therefore, it is an object of the invention to remove these corrosion products, both activated and non-activated, that cannot be removed via cleanup or ultrasonic fuel cleaning;

It is another object of the invention to collect the corrosion products safely on a combination filter/ion exchange system;

It is another object of the invention to remove other small debris that may have been deposited in the reactor over time.

These and other objects and advantages of the invention are disclosed below, where a vacuum assembly is provided for cleaning foreign matter from a nuclear reactor vessel, vessel components, and reactor coolant during reactor outage. The vacuum assembly includes a vacuum head for being inserted into the vessel and a first pump fluidly communicating with the vacuum head for directing water under pressure in the area of the vacuum head onto component surfaces within the vessel to be cleaned and thereby dislodging foreign matter from the surfaces into suspension in the reactor coolant. Filters remove foreign matter suspended in the reactor coolant from the reactor coolant, and a second pump fluidly communicating with the vacuum head for pumping reactor coolant through the filters from an upstream side to a downstream side for accumulating foreign matter on an upstream side of the filters while passing filtered coolant therethrough.

In accordance with one embodiment of the invention, one or more pressure nozzles are provided through which the coolant under pressure is ejected onto the vessel components.

In accordance with another embodiment of the invention, a vacuum nozzle conveys the coolant under pressure to the filters.

In accordance with another embodiment of the invention, the pressure nozzle is centrally disposed on a lower surface of the vacuum head and the vacuum nozzle is peripherally disposed on the lower surface of the vacuum head in surrounding relation to the pressure nozzle.

In accordance with another embodiment of the invention, the vacuum head is mounted on a telescoping extension arm, an upper end of which is mounted on a bridge adapted for being positioned over the vessel for enabling the vacuum head to be alternately lowered into and raised from the vessel.

In accordance with another embodiment of the invention, the telescoping extension arm is mounted for translating movement relative to the vessel for permitting the vacuum head to be moved laterally within the vessel.

In accordance with another embodiment of the invention, the filters are submerged within the reactor cavity during operation.

In accordance with a method embodiment of the invention, the method of cleaning foreign matter from nuclear reactor vessel components and reactor coolant during reactor outage, includes the steps of providing a vacuum head for insertion into the vessel, directing water under pressure in the area of the vacuum head onto component surfaces within the vessel to be cleaned, and dislodging foreign matter from the surfaces into suspension in the reactor coolant. Filters are provided for removing foreign matter suspended in the reactor coolant from the reactor coolant. The reactor coolant and entrained foreign matter is pumped through the filters from an upstream side to a downstream side, and the foreign matter is accumulated on an upstream side of the filters while passing filtered coolant therethrough.

In accordance with another embodiment of the invention, the method includes the step of telescoping the vacuum head into the vessel from a position above the vessel at a beginning of a cleaning operation and telescoping the vacuum head out of the vessel from a position above the vessel at an ending of the cleaning operation.

In accordance with another embodiment of the invention, the method includes the step of moving the vacuum head laterally within the vessel into proximity to the component surfaces within the vessel to be cleaned.

In accordance with another embodiment of the invention, the method includes the step of performing the cleaning operation remotely by means of a camera.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic cutaway view of a reactor vessel and a schematic of a refuel bridge of a nuclear power plant, on which is mounted an apparatus for removing corrosion products from a nuclear reactor according to one embodiment of the invention, with parts omitted and simplified for clarity;

FIG. 2 is a schematic view of the system components of an apparatus for removing corrosion products from a nuclear reactor according to one embodiment of the invention;

FIG. 3 is a schematic view of a vacuum head for the apparatus of FIG. 2; and

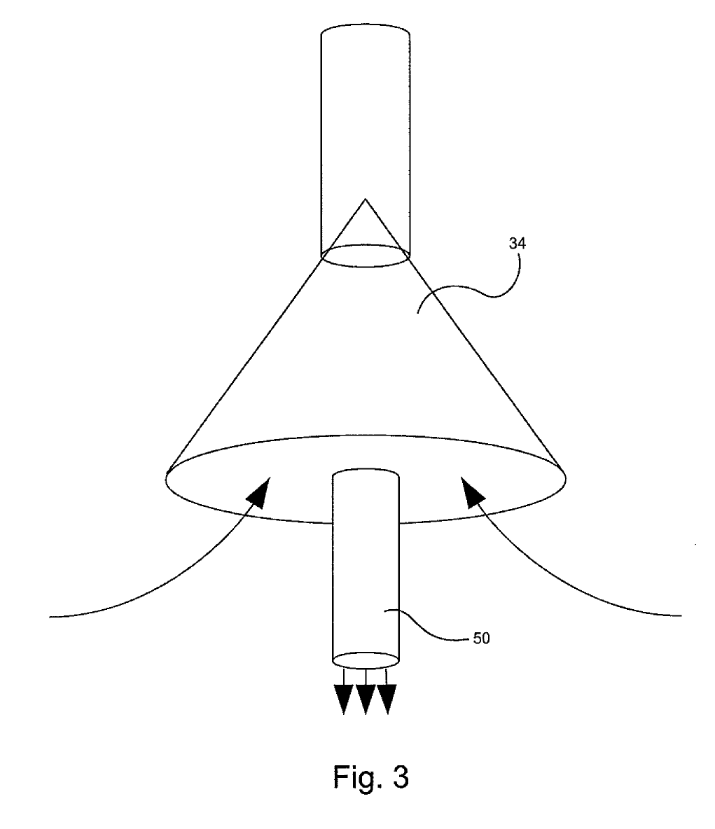

FIG. 4 is a schematic view of the vacuum head in place on a lower core plate during a corrosion removal process.

### DESCRIPTION OF THE PREFERRED EMBODIMENT AND BEST MODE

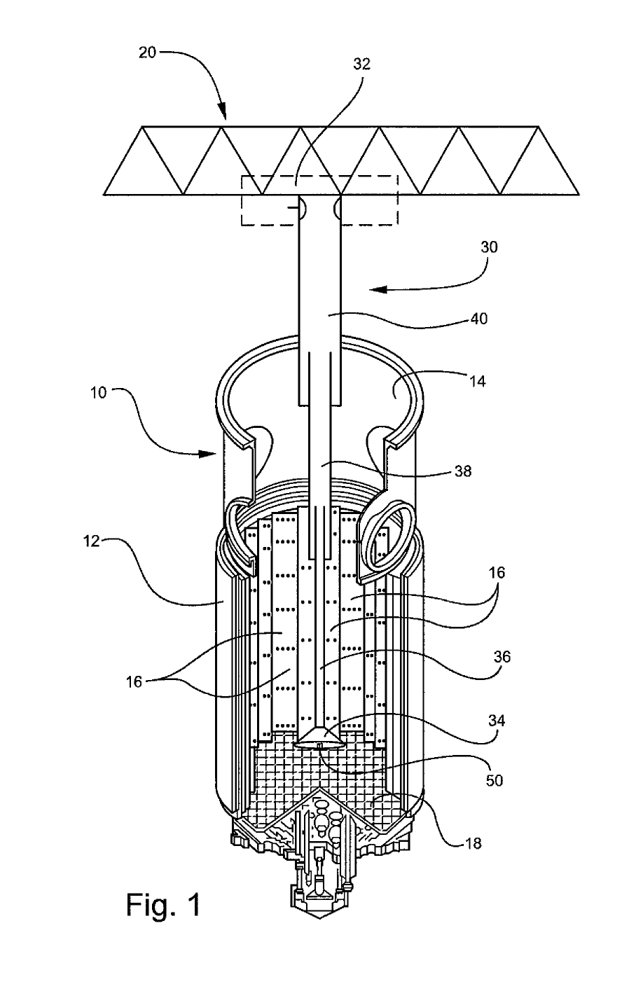

Referring now specifically to the drawings, FIG. 1 includes a cutaway view of a nuclear reactor pressure vessel 10. The pressure vessel 10 includes generally cylindrical vessel walls 12 having a top opening 14 through which fuel assemblies 16 are inserted into and removed from the vessel 10. The vessel 10 contains an upper support plate, upper core plate (not shown), and a lower core plate 18 positioned in the bottom area of the vessel 10.

A refuel bridge 20, constructed of suitable beams, extends across the top of the vessel 10, from which is suspended a vacuum assembly 30 according to an embodiment of the invention. The vacuum assembly 30 may be mounted on the refuel bridge 20 and includes a combined pump/filter system 32 that is designed to vacuum the surface of the lower core plate 18, filter water within the vessel 1I 0 as well as provide a removal mechanism for small debris in the bottom area of the vessel 10 below the lower core plate 18. Alternatively, the vacuum assembly 30 may be positioned over the vessel 10 by other means.

The vacuum assembly 30 is utilized during the refuel outage of a nuclear plant when the plant has entered the outage and the core is being refueled. During an outage, the reactor head is removed and the reactor vessel is filled with water so the fuel is always submerged during refueling operations. The cavity is essentially a stainless steel pool above the reactor pressure vessel 10. When the plant is shutdown, the reactor pressure vessel head is removed and the pool filled with water so the fuel can be transferred under water. Because the fuel assemblies are typically about 14 feet long, at least that much water is needed over the top of the reactor.

The fuel assemblies 16 are removed from the vessel 10 using an overhead crane, and are sent to a spent fuel storage location or shuffled inside the vessel 10.

When the fuel is moved, mechanical vibrations may dislodge loosely held crud that may then settle to the bottom of the vessel 10. The vacuum assembly 30 is intended to vacuum these dislodged corrosion products as well as other small foreign material. The corrosion products are collected on filters that can be stored in the spent fuel pool until they are disposed in a licensed nuclear waste burial facility.

The vacuum assembly 30 removes both activated and non-activated corrosion products. Activated corrosion products with half lives greater than 150 days, such as cobalt-60, will be removed and thus reduce ex-core radiation fields in future outages. Parent nuclides for shorter lived nuclides, such as nickel-58, will also be removed and assist in reducing ex-core dose rates in future outages. This supports the RP2020 initiative of source term reduction.

If there are debris that are smaller than the debris filters at the bottom of the vessel 10, the vacuum assembly 30 dislodges the debris and removes it safely. In addition, if crud reload occurs, then removal of that crud should help fuel performance by reducing the inventory of crud on the fuel. This effect would be most significant in plants that have high releases of corrosion products from their steam generators.

The use of the vacuum assembly 39 is also intended to produce research benefits, including understanding the amount of activity at the bottom of a core as well as determining the mass of potential parent nuclides. Samples may be extracted from the vacuum assembly 30 during use and used for chemical and radiological analysis.

The vacuum assembly 30 is designed so as not to damage the fuel assemblies 18. Thus, plants with full-core offload during outages are preferred candidates for use of this vacuum assembly 30. No foreign material is deposited in the core.

The system is preferably operated remotely and presents little to no ALARA (As Low As Reasonably Achievable) concerns. The waste generated is no greater than Class C, with Class A waste being preferred.

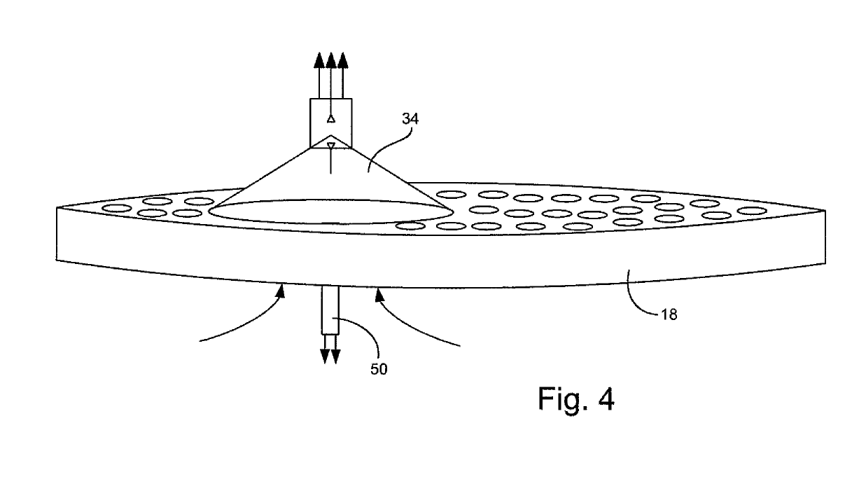

Referring now more specifically to the drawings, the vacuum assembly 30 includes a vacuum head 34 made of a material, such as stainless steel. The vacuum head 34 pumps water below the lower core plate 18 and loosens foreign material, as shown in FIG. 4. The vacuum head 34 is mounted for movement within the vessel 10 on the end of a series of telescoping guide tubes 36, 38, 40 that collectively form an extension arm.

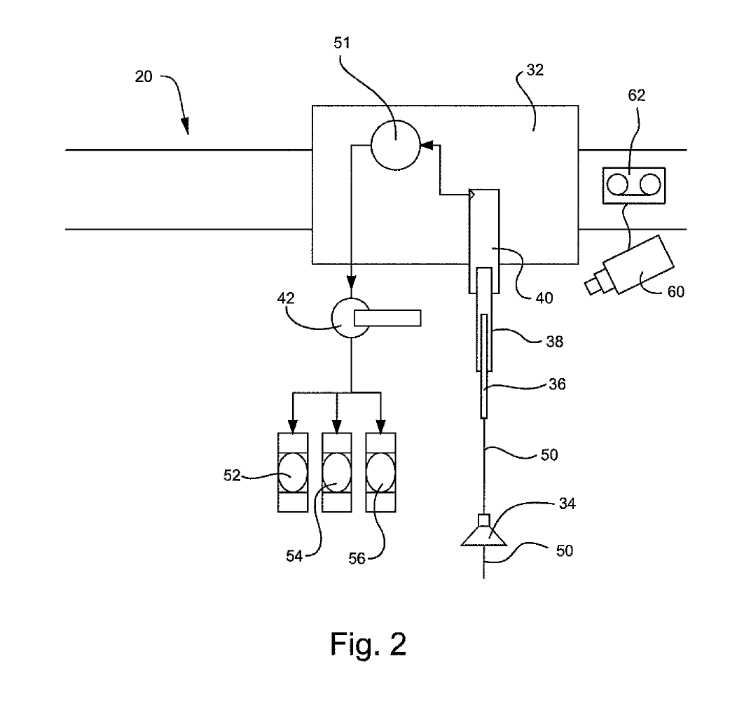

The vacuum assembly 30 also includes two pumps 42, 44. Pump 42 provides suction that pumps water to the filters, as shown in FIG. 2, and another pump 44 to provide the water under sufficient pressure to actually perform the cleaning operation. The pump 42 is preferably an axial ‘torpedo’ pump, and the pressure wash pump 44 is selected based on performance criteria unique to the vessel being cleaned, and may be a centrifugal-type type pump.

A hose 50 extends through and from the telescoping guide tubes 36, 38, 40 and supplies pressurized water to the vacuum head 34. The hose 50 is selected based on flow rate requirements. The hose 50 should be of material that does not retain a curvature after being pushed through the guide tube tubes 36, 38, 40. Hose guides, not shown, are used to direct the vaccum head during operation. A hose reel 51 may be used to store the hose 50 and to pay out and retract the hose during the vacuuming/filtration process.

In the case of incomplete off-loading, a hose fabricated from organic material is not acceptable because of neutron degradation. In such cases, an extendable metal shaft, not shown, is substituted for the hose 50, and extends from the telescoping guide tubes substantially as shown in FIG. 2.

As is shown in FIG. 2, underwater filters 52, 54, 56 are used in order to minimize an acquired radiation dose while handling. The filters 52,54,56 are preferably Tri-Nuc filters, which comprise elongate cartridges having a filter media of polypropylene, melt brown reinforced typar, that is available in varying mesh sizes, such as 0.3, 1, 5, 10 and 20 microns. The filter media is enclosed within a stainless steel screen shroud. The use of three filters 52, 54, 56 is for illustration purposes only, and any suitable number of filters may be used. The filters 52, 54, 56 are preferably non-backflush-type filters, and are disposed of when filtration efficiency drops below a predefined point by sealing the expended filters in drums, such as UN1A2 55 gallon drums in accordance with industry practice, and shipping the drums to a suitable waste storage facility.

The filters 52, 54, 56 are remotely detachable to limit personnel exposure to radiation. A remote camera 60 is used to direct the vacuum head 34. A recording device, such as a video recorder 62, may be used to document the process and provide archival information.

As is shown in FIG. 4, the vacuum head 34 is designed to suck water through the funnel shaped portion, functioning as a suction or vacuum nozzle, while pumping water through the hose 50, functioning as a pressure nozzle, to dislodge material in the reactor vessel 10. FIG. 4 shows particular usage of the vacuum head 34 to pump water below the lower core plate 18 and draw it back through holes in the core plate 18 for transport to the filters 52, 54, 56.

A method and apparatus for for cleaning foreign matter from a nuclear reactor vessel, vessel components, and reactor coolant during reactor outage is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A vacuum assembly for cleaning foreign matter from a nuclear reactor vessel, vessel components, and reactor coolant during reactor outage, including:
(a) a vacuum head for being inserted into the vessel;
(b) a first pump fluidly communicating with the vacuum head for directing water under pressure in the area of the vacuum head onto component surfaces within the vessel to be cleaned and thereby dislodging foreign matter from the surfaces into suspension in the reactor coolant;
(c) a filter for removing foreign matter suspended in the reactor coolant from the reactor coolant; and
(c) a second pump fluidly communicating with the vacuum head for pumping reactor coolant through the filter from an upstream side to a downstream side for accumulating foreign matter on an upstream side of the filter while passing filtered coolant therethrough.

2. A vacuum assembly according to claim 1, and including a pressure nozzle through which the coolant under pressure is ejected onto the vessel components.

3. A vacuum assembly according to claim 1, and including a vacuum nozzle through which the coolant under pressure is conveyed to the filter.

4. A vacuum assembly according to claim 1, wherein the pressure nozzle is centrally disposed on a lower surface of the vacuum head and the vacuum nozzle is peripherally disposed on the lower surface of the vacuum head in surrounding relation to the pressure nozzle.

5. A vacuum assembly according to claim 1, wherein the vacuum head is mounted on a telescoping extension arm, an upper end of which is mounted on a bridge adapted for being positioned over the vessel for enabling the vacuum head to be alternately lowered into and raised from the vessel.

6. A vacuum assembly according to claim 5, wherein the telescoping extension arm is mounted for translating movement relative to the vessel for permitting the vacuum head to be moved laterally within the vessel.

7. A vacuum assembly according to claim 5, wherein the filter is submerged within the reactor vessel during operation.

8. A method of cleaning foreign matter from nuclear reactor vessel components and reactor coolant during reactor outage, including the steps of:
(a) providing a vacuum head for insertion into the vessel;
(b) directing water under pressure in the area of the vacuum head onto component surfaces within the vessel to be cleaned, and dislodging foreign matter from the surfaces into suspension in the reactor coolant;
(c) providing a filter for removing foreign matter suspended in the reactor coolant from the reactor coolant;
(d) pumping reactor coolant and entrained foreign matter through the filter from an upstream side to a downstream side; and
(e) accumulating the foreign matter on an upstream side of the filter while passing filtered coolant therethrough.

9. A method according to claim 8, and including the step of telescoping the vacuum head into the vessel from a position above the vessel at a beginning of a cleaning operation and telescoping the vacuum head out of the vessel from a position above the vessel at an ending of the cleaning operation.

10. A method according to claim 8, and including the step of moving the vacuum head laterally within the vessel into proximity to the component surfaces within the vessel to be cleaned.

11. A method according to claim 8, and including the step of performing the cleaning operation remotely by means of a camera.
